(19) United States
(12) Patent Application Publication
(10) Pub. No.: US 2012/0047352 A1
(43) Pub. Date: Feb. 23, 2012

(54) PROCESSOR

(75) Inventor: Tomohiro YAMANA, Kyoto (JP)

(73) Assignee: PANASONIC CORPORATION, Osaka (JP)

(21) Appl. No.: 13/285,137

(22) Filed: Oct. 31, 2011

Related U.S. Application Data
(63) Continuation of application No. PCT/JP2010/002939, filed on Apr. 23, 2010.

(30) Foreign Application Priority Data
May 8, 2009 (JP) 2009-113996

(51) Int. Cl. G06F 9/312

(52) U.S. Cl. 712/215; 712/E09.033

(57) ABSTRACT

A processor includes: an instruction buffer which stores the instructions to be dispatched to the arithmetic units; a dependency detecting unit which (i) detects a first dependency and a second dependency and (ii) determines an instruction group including the instructions to be dispatched to the corresponding arithmetic units, the first dependency found between any given two of the instructions stored in the instruction buffer, the second dependency found between each of the instructions stored in the instruction buffer and each of the dispatched instructions, and the instruction group including at least one instruction (i) found in the instructions stored in the instruction buffer and (ii) having neither the first dependency nor the second dependency; and a dispatching unit which dispatches, to the corresponding one of the arithmetic units, the instruction included in the determined instruction group.

### CROSS REFERENCE TO RELATED APPLICATIONS

This is a continuation application of PCT Patent Application No. PCT/JP2010/002939 filed on Apr. 23, 2010, designating the United States of America, which is based on and claims priority of Japanese Patent Application No. 2009-113996 filed on May 8, 2009. The entire disclosures of the above-identified applications, including the specifications, drawings and claims are incorporated herein by reference in their entirety.

### BACKGROUND OF THE INVENTION

(1) Field of the Invention

The present invention relates to processors enabling parallel execution of multiple instructions and, in particular, to a processor having a superscalar architecture.

(2) Description of the Related Art

Processors execute instruction sequences stored in memories. In order to enhance the performance of the processors, executable instructions can be simultaneously executed in parallel when processors execute the instruction sequences.

A superscalar is one of processor architectures capable of executing the multiple instructions in parallel. In the case where the definition of a resource (register, for example) has not finished because the instruction is currently being executed, the superscalar causes the hardware to stop dispatching an instruction which refers to the resource, and to execute, in advance, the following instruction having no dependencies.

The superscalar, however, inevitably includes a complex structure to retain a state of the processor immediately before the development of an exception, and to restore the processor to the state before the exception.

A Very Long Instruction Word (VLIW) is another processor architecture capable of executing the multiple instructions in parallel. In the VLIW, a compiler previously extracts executable instructions in parallel in compiling, and generates a parallel executable code including multiple instructions executable in parallel.

The processor in the VLIW is relatively simple in structure. Unfortunately, such a processor has problems of an increase in code size due to insertion of a NOP instruction and incompatibility with an existing instruction set.

As described above, the superscalar and the VLIW are used as techniques to execute multiple instructions in parallel. Each of the techniques has its own advantages and disadvantages.

Patent Reference 1 (Japanese Patent No. 3984786) discloses an example of an instruction dispatch control technique. In Patent Reference 1, dispatch of instructions is controlled per instruction group including one or more instructions in advance.

Furthermore, in Patent Reference 1, a table is prepared to store (i) information on a resource (such as a register file) to be defined and referred to by each of the instructions included in a predetermined group to be dispatched and (ii) wait time information of the resource. Patent Reference 1 proposes a technique to utilize the wait time information to detect a dependency between the instructions included in an already-dispatched instruction group and the instructions whose dispatch is controlled. In the case where the dependency is found, the technique stops dispatching the instructions included in an appropriate instruction group, and dispatches instructions included in an instruction group with no dependency.

The above dispatch control technique successfully extracts, before the dispatch of the instructions, an instruction group including one or more instructions having a dependency, and carries out scheduling of the instructions.

Patent Reference 2 (Japanese Unexamined Patent Application Publication No. 2008-123045, Paragraphs [0040] to [0045]) discloses another example of an instruction dispatch control technique. The Patent Reference 2 discloses an invention of a device which counts the number of simultaneously executable instructions in a thread, calculates the number of cycles to be spent for processing the threads, and, taking priority into consideration, efficiently dispatches the instructions in the threads.

In Patent Reference 2, Paragraphs [0040] to [0045] describes a typical technique of grouping instructions implemented in existing hardware.

In the above typical instruction grouping technique implemented before the dispatch of the instructions, the dependency is extracted only for the instructions included in an instruction group to be dispatched. Accordingly, instruction groups to be dispatched will be controlled.

### SUMMARY OF THE INVENTION

The dispatch control technique in Patent Reference 1 requires the processor to hold instructions having a dependency in an instruction queue, and to carry out dispatch control on multiple instruction groups while sequentially detecting the dependency. Moreover, the instruction scheduling is dynamically carried out per instruction group at the time of instruction dispatch. This necessitates an extra cost for hardware for restoring the state of the processor when an exception occurs after the dispatch of the instructions. Thus, unfortunately, the dispatch control technique in Patent Reference 1 would complicate the hardware due to the above two reasons.

In the technique disclosed in Patent Reference 2, the limitation of the grouping would prevent dispatch control executed with grouping based on (i) the dependency between instructions in an instruction group and (ii) the dependency between instructions across instruction groups. This problem could develop a penalty cycle at the time of executing instructions unless otherwise developed if the grouping were appropriately carried out. Thus, the conventional instruction grouping technique to be carried out before the instruction dispatch would fail to achieve the optimum performance.

The present invention is conceived in view of the above problems and has an object to provide a processor capable of determining, using simple hardware, an efficient dispatch group (instruction grouping) in terms of performance when issuing the instructions.

In order to achieve the above object, a processor according to an aspect of the present invention simultaneously dispatches a plurality of instructions to a plurality of arithmetic units. The processor includes: an instruction buffer which stores the instructions to be dispatched to the arithmetic units; a group determining unit which (i) detects a first dependency and a second dependency and (ii) determine an instruction group including the instructions to be dispatched to the corresponding arithmetic units, the first dependency being found between any given two of the instructions stored in the instruction buffer, the second dependency being found between each of the instructions stored in the instruction buffer and each of the dispatched instructions, and the group including at least one instruction (i) being found in the instructions stored in the instruction buffer and (ii) having neither the first dependency nor the second dependency; and a dispatching unit which dispatches, to the corresponding one of the arithmetic units, the instruction included in the group determined by the group determining unit.

The essential cause of a penalty cycle developed between the instruction groups by an instruction grouping scheme employed with existing hardware is that the existing hardware is designed to take into consideration only the dependency between the instructions stored in an instruction buffer, and thus cannot detect the dependency with an already-dispatched instruction group.

This structure allows the determination of an instruction group to be issued at the next cycle with reference to the dependency with an already-dispatched instruction, as well as the dependency between the instructions stored in the instruction buffer. This feature successfully reduces penalties between the dispatched instruction groups and determines, using simple hardware, an efficient dispatch group (instruction grouping) in terms of performance when issuing the instructions.

It is noted that, instead of the processor including the characteristic processing units, the present invention may also be provided as an instruction dispatching method implementing the processes executed by the characteristic processing units included in the processor as steps. Furthermore, the present invention may also be provided as a program which causes a computer to execute the characteristic steps included in the instruction dispatching method. As a matter of course, such a program may be distributed via a non-volatile storage medium such as a Compact Disc-Read Only (CD-ROM), and a communications network such as the Internet.

The present invention executes instruction grouping by detecting a dependency between an instruction in an instruction buffer and an instruction in an already-dispatched instruction group, as well as a dependency between instructions in an instruction buffer to be dispatched. This feature successfully reduces penalties between the dispatched instruction groups and contributes to performance improvement.

The following two reasons detail why the present invention successfully demonstrates the performance improvement:

(i) An instruction to be originally dispatched ahead is simultaneously dispatched together with a succeeding instruction having a dependency with an already-dispatched instruction, which solves a problem that the instruction to be dispatched inevitably waits its dispatch together with the succeeding instruction having the dependency until the already-dispatched instruction has completely executed; and

(ii) In the case where the parallelism improves when the grouping is executed using the succeeding instruction having a dependency with the already-dispatched instruction as the initial instruction of an instruction dispatch, the deterioration of grouping efficiency due to the lack of the succeeding instruction as the initial instruction can be curbed.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 compares performance based on ideal instruction grouping with performance based on instruction grouping on existing hardware;

FIG. 2 shows a structure of the existing hardware (a conventional processor);

FIG. 3 shows the details of the instruction grouping executed on the existing hardware;

FIG. 4 shows a structure of a processor according to an embodiment of the present invention;

FIG. 5 exemplifies a resource state storage table;

FIG. 6 exactly shows the details of the grouping executed by the processor according to the embodiment of the present invention;

FIG. 7 shows the performance based on the instruction grouping executed by the processor according to the embodiment of the present invention;

FIG. 8 depicts a flowchart showing how to detect a resource in a non-ready state;

FIG. 9 depicts a flowchart showing how to write data in the resource state storage table; and

FIG. 10 depicts a flowchart showing how to control instruction dispatch.

### DESCRIPTION OF THE PREFERRED EMBODIMENT

Described first are a processor having a typical superscalar architecture, followed by a processor according to the embodiment.

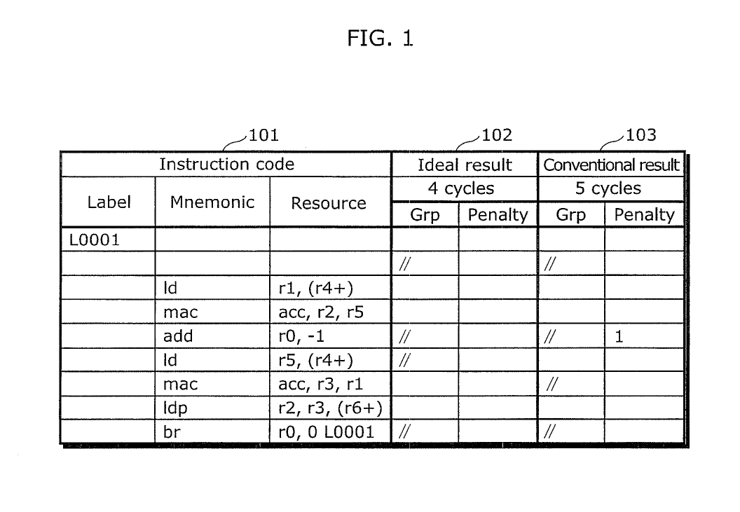

FIG. 1 shows a comparison between performances by two types of instruction grouping.

The comparison table in FIG. 1 includes fields of an instruction code 101, an ideal result 102, and a conventional result 103.

The instruction code 101 shows instruction codes to execute looping, and includes the label of a branch destination, the instruction codes expressed in mnemonic form, and resources to be referred to and defined by the instructions.

Here, a processor (not shown), executing each of the instructions in the instruction code 101, can execute as many as three instructions in parallel. The processor includes a load and store unit, a product-sum operation unit, an arithmetic logic unit, and a branch execution unit. However, the present invention shall not be limited by a structure, such as (i) the maximum number of executable instructions in parallel in a processor, and (ii) the type and the number of units.

An Id and an Idp in the instruction code 101 are a load instruction and load-pair instruction, respectively, and are executed by the load and store unit. A mac is a product-sum instruction executed by the product-sum operation unit. An add is an add instruction executed by the arithmetic logic unit. A br is a branch instruction executed by the branch execution unit. Any person skilled in the art may easily expect the details of the above instructions. Thus, the details shall not be repeated.

Here, the following is assumed: The Id and the Idp take 2 cycles spent until their executions end; that is they have a latency of 2 cycles, and the other instructions have a latency of 1 cycle. These execution cycles, however, are tentative definitions, and the present invention shall not be limited by those definitions of the number of cycles.

The ideal result 102 in the comparison table in FIG. 1 shows an ideal result of instruction grouping. The “//” in the Grp column in the ideal result 102 shows that the instruction codes up to the row of the “//” are defined as a dispatch group (a group of instructions to be dispatched in a single cycle), and that the instruction immediately after the dispatch group is defined as the initial instruction code of a new dispatch group. The Penalty column indicates a penalty cycle. The column indicates the number of penalty cycles when the instruction groups up to the row of the “//” stall executions of any of instructions of the following dispatch groups.

The result of the instruction grouping in the ideal result 102 is described as follows:

[Id r1, (r4+)] [mac acc, r2,r5] [add r0, −1] (a first instruction group);

[Id r5, (r4+)] (a second instruction group); and

[mac acc, r3, r1] [Idp r2, r3, (r6+)] [br r0, 0 L0001] (a third instruction group)

The ideal result 102 shows the result of instruction grouping having no penalty cycle between instruction groups; that is, the instruction grouping is efficient in terms of performance.

This is because no penalty cycle develops between the first instruction group (Id, mac, add) and the second instruction group (Id), and between the second instruction group (Id) and the third instruction group (mac Idp, br). In other words, when a dependency is found between the instruction groups, the resources can be referred to before all the instructions start to be executed.

The conventional result 103 in the comparison table in FIG. 1 shows the result of instruction grouping by the conventional instruction grouping process. The result of the instruction grouping in the conventional result 103 is described as follows:

[Id r5, (r4+)] [mac acc, r2,r5] [add r0, −1] (a first instruction group);

[Id r1, (r4+)] [mac acc, r3,r1] (a second instruction group);

[Idp r2, r3, (r6+)] [br r0, 0 L0001] (a third instruction group)

In the conventional result 103, no consideration is made of a dependency between the instruction groups. Thus, a penalty cycle develops by a true dependency between the first instruction group (Id, mac, add) and the second instruction group (Id, mac). This is because a register r1 defined by Id is referred to by mac in the next cycle. It takes 2 cycles to finish executing Id, which develops 1 penalty cycle before the execution of mac.

Consequently, it takes four cycles in the ideal result 102 to execute 1 loop as shown below.

3(dispatch cycle of 3 instructions)+1(loop-carried dependency cycle of Idp)=4

In contrast, it takes five cycles in the conventional result 103 to execute 1 loop as shown below.

3(dispatch cycle of 3 instructions)+(penalty cycle caused by dependency of the register r1)+1(loop-carried dependency cycle of Idp)=5

The difference of no more than 1 cycle is a penalty cycle in the repeatedly executed loop, which makes the problem obvious as a performance loss of 25% occurs in processing of a medium.

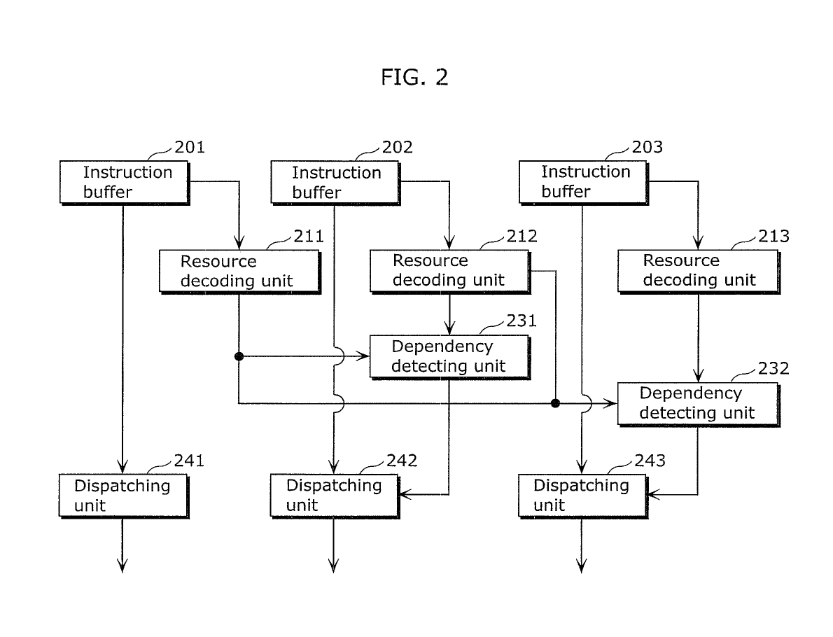

Described next is the reason why the above grouping is inevitably executed in the conventional result 103. FIG. 2 shows a structure of the existing hardware (a conventional processor). In FIG. 2, typical instruction dispatch control is carried out on the presumption of in-order parallel execution. It is noted that FIG. 2 shows a processor capable of executing three instructions in parallel; however, the present invention shall not be limited to the number of executable instructions in parallel.

The processor includes instruction buffers 201 to 203, resource decoding units 211 to 213, dependency detecting units 231 and 232, and dispatching units 241 to 243.

Each of the instruction buffers 201 to 203 is a storage unit for storing instructions fetched from an instruction cache (not shown).

Each of the resource decoding units 211 to 213 extracts information on (i) a resource defined or referred to by the instructions stored in the instruction buffers 201 to 203 and (ii) an arithmetic unit executing the instructions.

Each of the dependency detecting units 231 and 232 detects (i) a dependency in the arithmetic unit executing the instructions and (ii) a dependency in a resource defined or referred to by the instructions. In other words, each of the dependency detecting units 231 and 232 detects (i) the dependency between the instructions executed on the same arithmetic unit and (ii) the dependency between the instructions which define or refer to the same resource.

The dispatching units 241 to 243 dispatch accordingly each of the instructions included in an instruction group to the arithmetic unit.

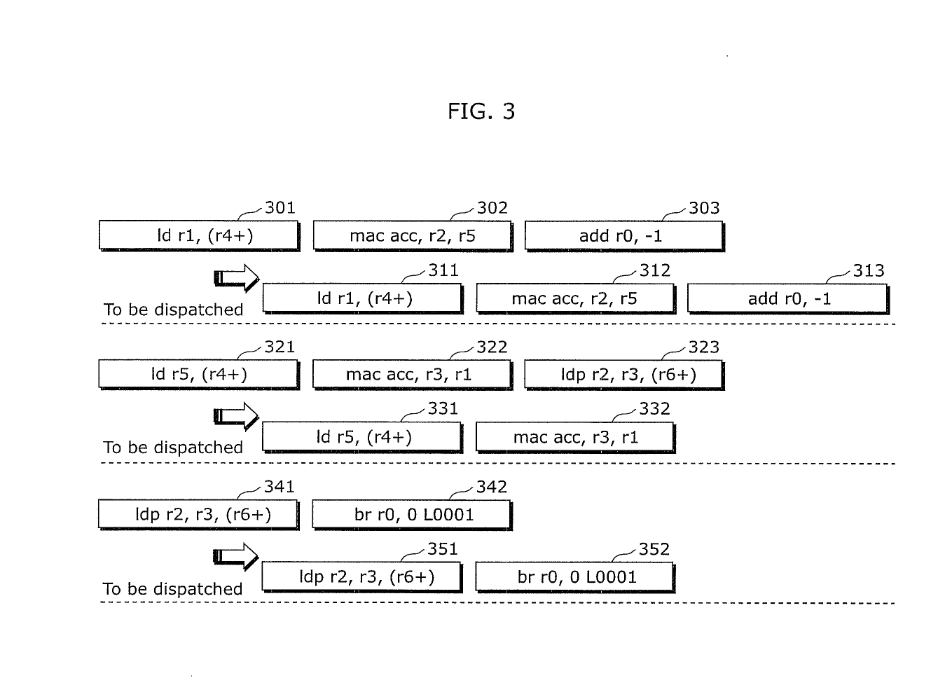

FIG. 3 shows the details of the grouping executed on the existing hardware shown in FIG. 2. First, neither of resource constraint nor data dependency constraint is found between instructions 301 to 303 respectively stored in the instruction buffers 201 to 203. Thus, all of the three instructions; that is the maximum number of instructions to be executed in parallel, are dispatched by the dispatching units 241 to 243. Accordingly, each of the instructions 311 to 313 is dispatched to a corresponding arithmetic unit.

Then, the instruction buffers 201, 202, and 203 respectively store instructions 321, 322, and 323. Here, both of the instructions 321 and 323 are executed by the load and store unit, and cannot be simultaneously executed. Thus a resource constraint occurs between the instructions 321 and 323. Hence, only instructions 331 and 332 are dispatched.

Finally, the instruction buffers 201 and 202 respectively store instructions 341 and 342. Neither resource constraint nor data dependency constraint is found between the instructions 341 and 342. Thus, instructions 351 and 352 are dispatched.

Here, the instruction 332 (mac) of the second instruction group refers to the register r1 defined by the instruction 311 (Id) of the first instruction group. Accordingly, the data dependency; namely the true dependency, develops between the first and the second instruction groups. The latency of Id is 2 cycles. This inevitably develops a penalty of 1 cycle before starting the instructions in the second instruction group. Thus, the comparison table in FIG. 1 shows “1” in Penalty item in the row of add in the conventional result 103.

Since no penalty cycle develops in the ideal instruction grouping, the performance loss of 5/4=1.25; namely 25%, appears obvious in the instruction grouping executed in the existing hardware.

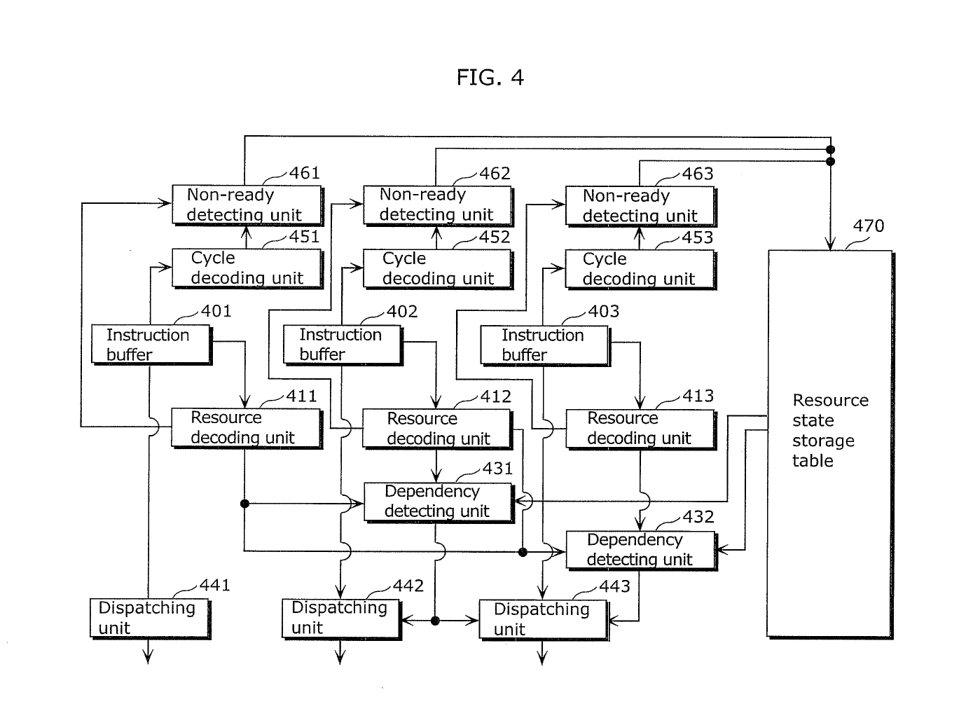

FIG. 4 shows a structure of a processor according to the embodiment of the present invention. The processor according to the embodiment can execute as many as three instructions in parallel. The present invention, however, shall not be limited by the number of instructions to be executed in parallel.

The processor includes instruction buffers 401 to 403, resource decoding units 411 to 413, dispatching units 441 to 443, cycle decoding units 451 to 453, non-ready detecting units 461 to 463, dependency detecting units 431 and 432, and a resource state storage table 470.

The instruction buffers 401 to 403, the resource decoding units 411 to 413, and the dispatching units 441 to 443 are the constituent features respectively having similar functions as those of the instruction buffers 201 to 203, the resource decoding units 211 to 213, and the dispatching units 241 to 243 in the existing hardware shown in FIG. 2. Thus, the details thereof shall be not be repeated.

Described below are new and additional constituent features.

The cycle decoding units 451 to 453 decode the latencies of instructions stored in the respective instruction buffers 401 to 403.

The non-ready detecting units 461 to 463 receive (i) latencies of the instructions stored in the instruction buffers 401 to 403 and outputted from the corresponding cycle decoding units 451 to 453 and (ii) resource information defined by the instructions stored in the instruction buffers 401 to 403 and outputted from the corresponding resource decoding units 411 to 413. When the latencies are 2 or more, the non-ready detecting units 461 to 463 determine that the resources defined by the corresponding instructions are non-ready in a cycle after the dispatch of instruction groups. In other words, the non-ready detecting units 461 to 463 determine that the resources cannot be referred to or defined in a cycle (the next cycle) following the dispatch of the instruction groups.

The details will be described below.

Suppose an instruction code [Id r1, (r4+)] is stored in the instruction buffer 401. This instruction defines, in the register r1, a value of memory of an address to be specified when a register r4 is referred to. The instruction has a latency of 2. Thus, the register r1 defined by the instruction is determined as non-ready in the cycle after the dispatch of Id.

The above resource (the register r1) determined as non-ready is registered in the resource state storage table 470.

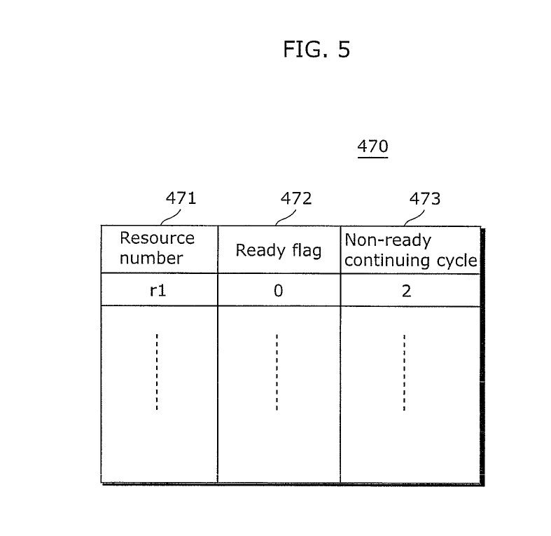

Here, the resource state storage table 470 is described. FIG. 5 exemplifies the resource state storage table 470. The resource state storage table 470 is a storage unit which stores a state of resources per resource. For each resource, the resource state storage table 470 stores a resource number 471, a ready flag 472, a non-ready continuing cycle 473.

The ready flag 472 shows whether or not the resource can be referred to from the next dispatch cycle. When the ready flag 472 is 1, the resource can be referred to immediately at the next dispatch cycle. In other words, the resource is not non-ready (ready). When the ready flag 472 is 0, the resource cannot be referred to immediately at the next dispatch cycle. In other words, the resource is non-ready.

The non-ready continuing cycle 473 indicates the number of cycles for which the non-ready state continues.

Back to the register r1, the register r1 is determined to be non-ready in the cycle after Id. Then, the resource state storage table 470 receives non-ready information outputted from the non-ready detecting unit 461. When the ready flag 472 of a table entry corresponding to the register r1 is 1, the resource state storage table 470 changes the ready flag 472 to 0, and registers 2 in the non-ready continuing cycle 473.

When the ready flag 472 is already 0, the resource state storage table 470 compares the number of the non-ready continuing cycles to be newly registered with the existing number of cycles stored in the non-ready continuing cycle 473. When the number of the non-ready continuing cycles to be newly registered is larger, the resource state storage table 470 registers the number of the new non-ready continuing cycles in the non-ready continuing cycle 473. When the number of the non-ready continuing cycles to be newly registered is smaller, the resource state storage table 470 does not register the new number of the non-ready continuing cycles in the non-ready continuing cycle 473. Accordingly, the number of existing cycles is left registered in the non-ready continuing cycle 473. The above has described how the resource state storage table 470 processes the non-ready information outputted from the non-ready detecting unit 461. Similar processing is executed in parallel on the non-ready information outputted from the non-ready detecting units 462 and 463.

The dependency detecting units 431 and 432 detect (i) a dependency (also referred to as a second dependency) between the instructions stored in the corresponding instruction buffers 401, 402, and 403 and entries of the corresponding resources in the resource state storage table 470, as well as (ii) the dependency (also referred to as a first dependency) between the instructions stored in the instruction buffers 401 to 403 as the existing hardware does. In other words, the dependency detecting units 431 and 432 refer to the ready flag 472 of the entry of each resource registered in the resource state storage table 470, and detect an instruction having a dependency on an entry in the non-ready state.

In the case of detecting a dependency either (i) between the instructions stored in the instruction buffers 401 to 403 or (ii) between the instructions stored in the corresponding instruction buffers 401, 402, and 403 and entries of the corresponding resources in the resource state storage table 470, the dependency detecting units 431 and 432 make a separation between the instruction having the dependency and the instruction immediately before the dependency-having instruction. Instructions up to the separation in the dispatch group are stored in the dispatching units 441 to 443, and accordingly dispatched to the arithmetic units.

When the dependency of the entries in the resource state storage table 470 determines a dispatch group, the non-ready detecting units 461 to 463 set the ready flag 472 of a corresponding entry to 1 and the non-ready continuing cycle 473 to 0.

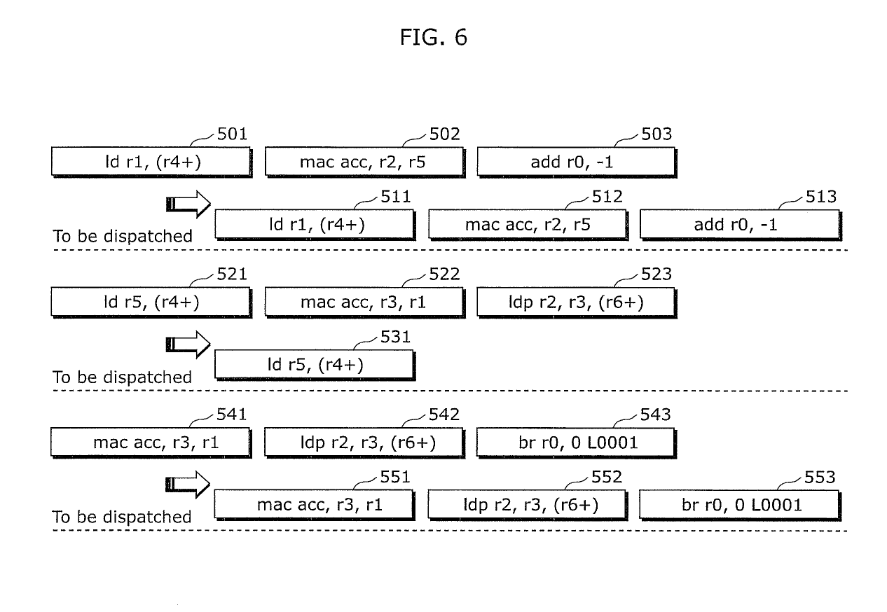

FIG. 6 shows the details of the grouping executed by the processor shown in FIG. 4. First, neither the resource constraint nor the data dependency constraint is found between the instructions 501 to 503 respectively stored in the instruction buffers 401 to 403. Thus, the dispatching units 441 to 443 dispatch all of the three instructions (instructions 511 to 513); that is the maximum number of instructions to be executed in parallel, to the corresponding arithmetic units.

Then, the instruction buffers 401 to 403 respectively store instructions 521 to 523. Here, both of the instructions 521 and 523 are executed by the load and store unit. Thus, a resource constraint occurs between the instructions 521 and 523. Furthermore, the register r1 develops a true dependency between the instructions 511 and 522, and the Id has the latency of 2. Thus, the register r1 cannot be referred to immediately after the execution of the instructions 511 to 513 in the first instruction group.

Thus, it is determined that the dependency is found between the instructions 511 and 522. Thus, only an instruction 521 immediately before the instruction 522 is included in the second instruction group. Hence, only the instruction 531 is dispatched.

Finally, the instruction buffers 401 to 403 respectively store instructions 541 to 543. Since neither a resource constraint nor a data dependency constraint is found between the instructions 541 to 543, instructions 551 to 553 are dispatched.

Such defining of the instruction groups makes it possible to finish executing the instruction 511 in the first instruction group before the instruction 541 in the third instruction group refers to the register r1 defined by the instruction 511 in the first instruction group. Thus, no penalty cycle develops between the instructions 511 and 551.

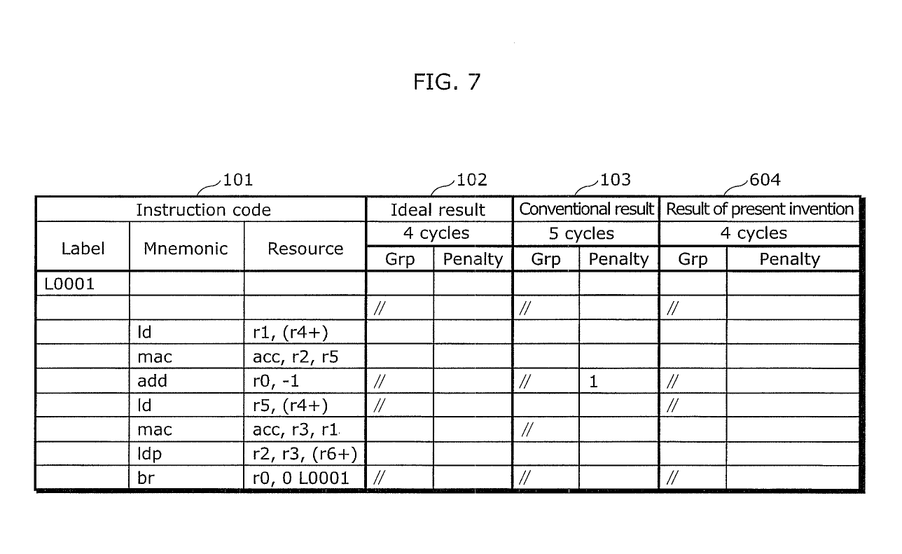

FIG. 7 shows the performance of the processor according to the embodiment. The comparison table in FIG. 7 has the comparison table in FIG. 1 include the field of the result of the present invention 604.

The field of the result of the present invention 604 indicates the result of the instruction grouping according to the embodiment. The instruction grouping by the existing hardware indicated in the field of the conventional result 103 shows the development of 1-cycle penalty. In the result of the present invention 604, however, no penalty cycle develops as the ideal result 102. Hence, the problem of the performance loss has been overcome.

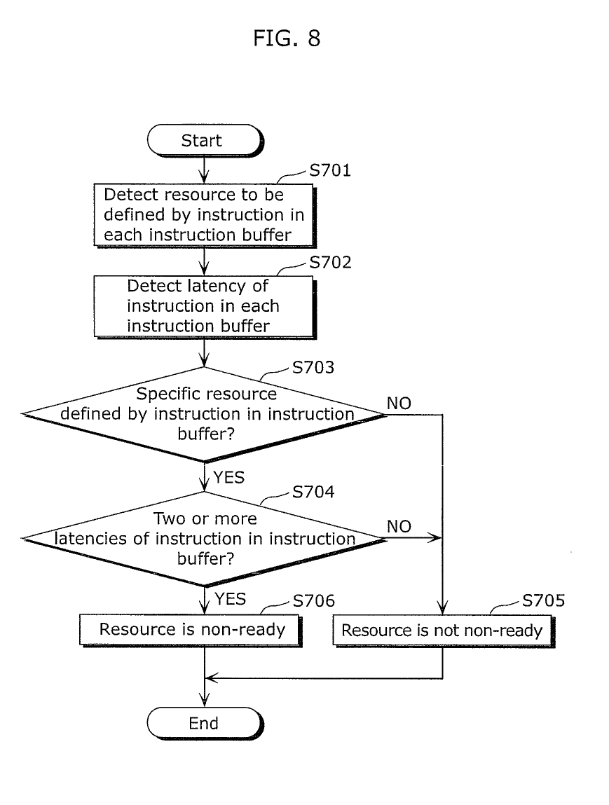

Detailed below is how the non-ready detecting units 461 to 463 in FIG. 4 execute their processes, following the brief outline of their operations described above. FIG. 8 depicts a flowchart showing how the non-ready detecting unit 461 detects a resource in a non-ready state. It is noted that the non-ready detecting units 462 and 463 execute processes similar to the process executed by the non-ready detecting unit 461, and thus the details thereof shall not be repeated.

First, the resource decoding unit 411 detects a resource to be defined by an instruction in the instruction buffer 401 (S701). Next, the cycle decoding unit 451 detects a latency of the instruction in the instruction buffer 401 (S702).

Based on the information obtained in S701 and S702, the non-ready detecting unit 461 determines whether or not the instruction in the instruction buffer 401 defines the resource to be used in the instruction itself (S703).

When determining that the instruction does not define the resource (S703: NO), the non-ready detecting unit 461 determines that the resource is not in the non-ready state; that is, the resource can be immediately referred to at the next dispatch cycle (S705).

When determining that the instruction defines the resource (S703: YES), the non-ready detecting unit 461 determines whether or not the latency of the instruction in the instruction buffer 401 is equal to 2 or greater (S704). When the latency is not equal to 2 or greater; that is the latency is 1 (S704: NO), the non-ready detecting unit 461 determines that the resource is not in the non-ready state; in other words, the resource can be immediately referred to at the next dispatch cycle (S705).

In contrast, when determining that the determinations made in S703 and S704 are both true, and the latency is equal to 2 or greater (S703: YES and S704: YES), the non-ready detecting unit 461 determines that the resource is non-ready (S706). The resource in the non-ready state shows that the resource cannot be immediately referred to at the next dispatch cycle.

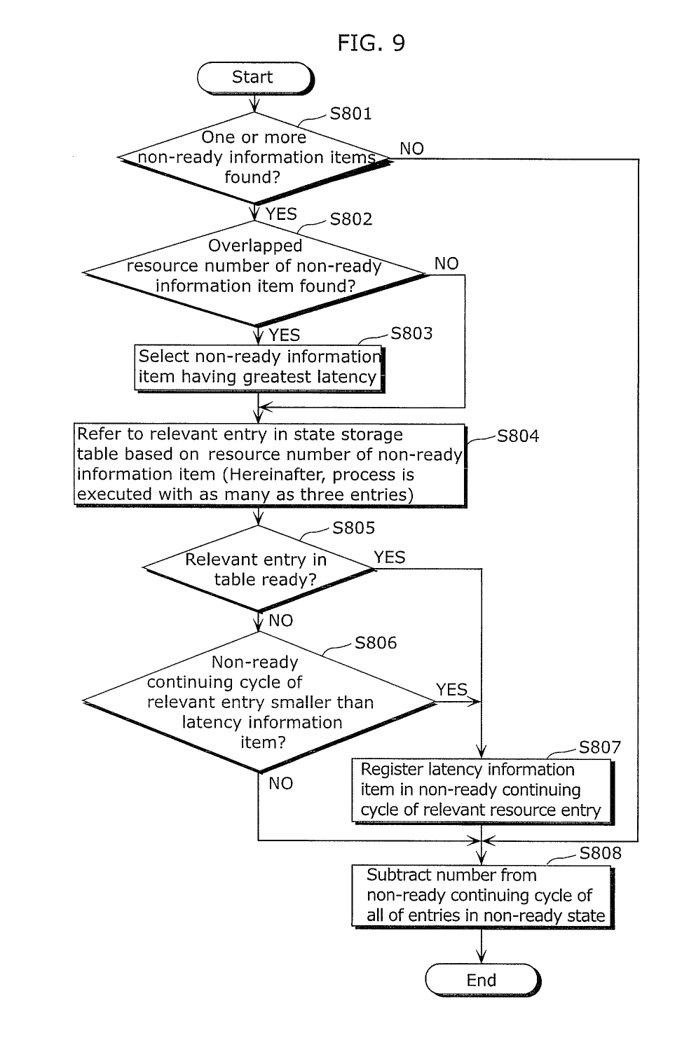

FIG. 9 depicts a flowchart showing how to write data in the resource state storage table 470.

First, the resource state storage table 470 receives non-ready information items (the resource number and the number of non-ready continuing cycles (=the latency of the instruction)) outputted from the non-ready detecting units 461 to 463. The resource state storage table 470 determines the total sum of the non-ready information items detected through the non-ready-state determining algorithm shown in FIG. 8 (S801). When none of the non-ready information items is found (S801: NO), the resource state storage table 470 subtracts a predetermined number (typically 1) from the non-ready continuing cycle 473 of all the entries in the non-ready state found in the table itself (S808).

When there is one or more of the non-ready information items (S801: YES), the resource state storage table 470 determines whether or not there is an overlapped resource number among the non-ready information items (S802). When the overlapped resource number is found among the non-ready information items (S802: YES), the resource state storage table 470 selects the non-ready information item having the greatest latency among the non-ready information items sharing the same resource number (S803).

The resource state storage table 470 refers to an entry of a relevant resource (the non-ready resource) in the table itself (S804). The entry reference and the subsequent entry detail update may be executed with a use of hardware for as many as three entries in parallel, when no overlapping is found among the non-ready information items outputted from the non-ready detecting units 461 to 463.

The resource state storage table 470 determines whether or not the relevant resource entry designated by the resource number of the non-ready information item is in the ready state (S805).

When the relevant resource entry is in the ready state (S805: YES), the resource state storage table 470 immediately changes the ready flag 472 of the relevant resource entry to 0, and registers the latency of the non-ready information item in the non-ready continuing cycle 473 (S807).

When the relevant resource entry has already been in the non-ready state (S805: NO), the resource state storage table 470 determines whether or not the non-ready continuing cycle 473 of the relevant resource entry is smaller than the latency of the non-ready information item (S806).

When the non-ready continuing cycle 473 of the relevant resource entry is smaller than the latency of the non-ready information item (S806: YES), the resource state storage table 470 immediately registers the latency of the non-ready information item in the non-ready continuing cycle 473 of the relevant resource entry (S807).

When the non-ready continuing cycle 473 of the relevant resource entry is equal to or greater than the non-ready information item (S806: NO), the number of the existing non-ready continuing cycles is directly held in the relevant entry of the resource state storage table 470.

Regardless of the presence or absence of the scheme in S807, the scheme in S808 is eventually executed.

The above process makes it possible to appropriately update the ready state of each of the resources in the resource state storage table 470.

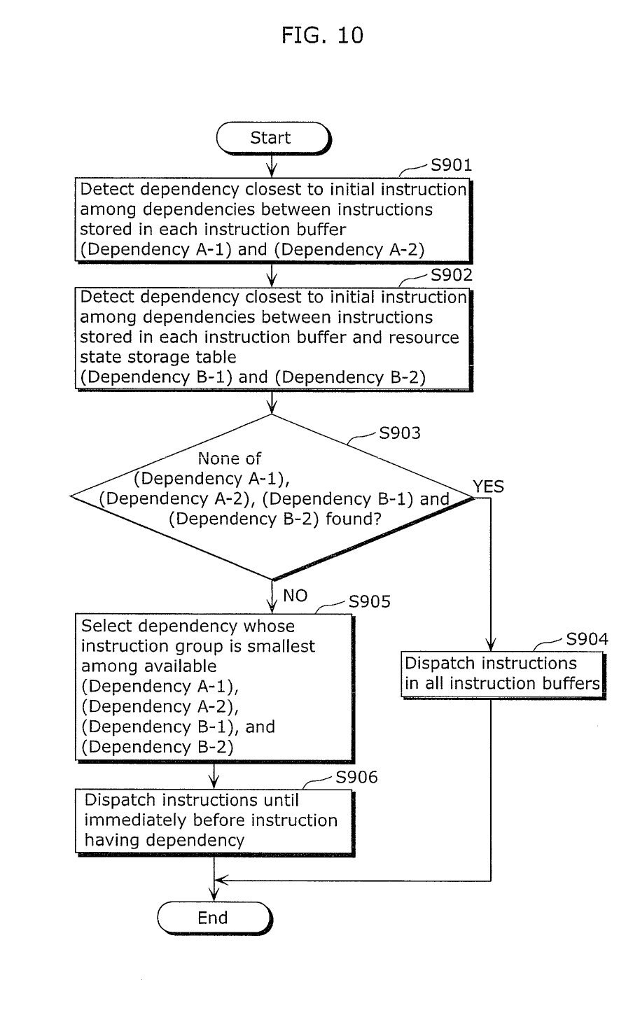

FIG. 10 depicts a flowchart showing how to control instruction dispatch.

First, the dependency detecting unit 431 detects a dependency between an instruction stored in the instruction buffer 401 and an instruction stored in the instruction buffer 402. This dependency is defined as (Dependency A-1) (S901).

Simultaneously, the dependency detecting unit 432 detects (i) a dependency between the instruction stored in the instruction buffer 401 and an instruction stored in the instruction buffer 403 and (ii) a dependency between the instruction stored in the instruction buffer 402 and the instruction stored in the instruction buffer 403. These dependencies are defined as (Dependency A-2) (S901).

Furthermore, as well as the above (Dependency A-1), the dependency detecting unit 431 detects a dependency between the instruction stored in the instruction buffer 402 and each of the resources in the resource state storage table 470. This dependency is defined as (Dependency B-1) (S902).

At the same time, as well as the above (Dependency A-2), the dependency detecting unit 432 detects a dependency between the instruction stored in the instruction buffer 403 and the entry of each of the resources in the resource state storage table 470. This dependency is defined as (Dependency B-2) (S902).

When none of (Dependency A-1), (Dependency A-2), (Dependency B-1), and (Dependency B-2) is found (S903: YES), the dispatching units 441 to 443 dispatch all the instructions stored in the instruction buffers 401 to 403 (S904).

Any one of (Dependency A-1), (Dependency A-2), (Dependency B-1), and (Dependency B-2) is found (S903: NO), the instruction dispatch control described below is executed.

In the case where (i) neither (Dependency A-2) nor (Dependency B-2) is found and (ii) either (Dependency A-1) or (Dependency B-1) is found, a dependency is found between (i) the instruction stored in the instruction buffer 402 and (ii) either the instruction stored in the instruction buffer 401 or the corresponding entry in the resource state storage table 470. Here, the dependency detecting unit 431 detects the above dependency, sends a control signal to the dispatching units 442 to 443, and prevents the dispatch of the instructions stored in the instruction buffers 402 and 403. In other words, dispatched is only the instruction stored in the instruction buffer 401 (S905 and S906).

In the case where (i) neither (Dependency A-1) nor (Dependency B-1) is found and (ii) either (Dependency A-2) or (Dependency B-2) is found, a dependency is found between (i) the instruction stored in the instruction buffer 403 and (ii) one of the instruction stored in either the instruction buffer 401 or the instruction buffer 402 and the corresponding entry in the resource state storage table 470. Here, the dependency detecting unit 432 detects the above dependency, sends a control signal to dispatching unit 443, and prevents the dispatch of the instruction stored in the instruction buffer 403. In other words, dispatched are only the instructions stored in the instruction buffers 401 and 402 (S905 and S906).

In the case where (i) either (Dependency A-1) or (Dependency B-1) is found and (ii) either (Dependency A-2) or (Dependency B-2) is found (mathematically expressed “((Dependency A-1)∥(Dependency B-1))&&((Dependency A-2)∥(Dependency B-2))”), prioritized is prevention of the dispatch from the instruction buffer 402. Specifically, in the case where either (Dependency A-1) or (Dependency B-1) is found, the dispatch from the instruction buffers 402 and 403 is prevented regardless whether or not either (Dependency A-2) or (Dependency B-2) is found. Accordingly, only the instruction stored in the instruction buffer 401 is dispatched (S905 and S906). Here, “&&” and “∥” respectively denote an AND operation and an OR operation.

The above process makes it possible to detect not only a dependency between the instructions stored in the instruction buffers 401 to 403, but also a dependency between the instructions in the instruction buffers 401 to 403 and the instructions in the instruction groups which have already been dispatched. This process successfully reduces penalties between the dispatched instruction groups and contributes to performance improvement.

Moreover, the above method is a process to be executed when there are three instruction buffers; however, in the case where two or more dependencies are found between the instructions when there are four or more instruction buffers, the method controls a dispatch group based on the dependency closest to the initial instruction. In other words, the same method is employed in controlling a dispatch group such that no dependency develops between instructions in instruction groups.

In addition, FIG. 4 is an example that the initial instruction buffer is fixed. It is also possible to execute a more efficient process such that instruction buffers are ring-coupled, a pointer showing the initial instruction according to the ring-coupling is updated, and control of the dependency detecting unit and the dispatching unit is changed based on the change of the initial pointer. Such a process, however, is not essential to the present invention, and details thereof shall be omitted.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The present invention introduces a technique which relates to the basis of a parallel-executable architecture and, in particular, a technique to successfully provide a processor having a great performance with simple hardware. The present invention can provide a simple architecture executable in parallel while maintaining binary compatibility.

Therefore, the present invention will provide a useful technology in any of the following fields: the embedding, the general-purpose Personal Computer (PC), and the super computing.

What is claimed is:

1. A processor which simultaneously dispatches a plurality of instructions to a plurality of arithmetic units, said processor comprising:
an instruction buffer which stores the instructions to be dispatched to the arithmetic units;
a group determining unit configured to (i) detect a first dependency and a second dependency and (ii) determine an instruction group including the instructions to be dispatched to the corresponding arithmetic units, the first dependency being found between any given two of the instructions stored in said instruction buffer, the second dependency being found between each of the instructions stored in said instruction buffer and each of the dispatched instructions, and the group including at least one instruction (i) being found in the instructions stored in said instruction buffer and (ii) having neither the first dependency nor the second dependency; and
a dispatching unit configured to dispatch, to the corresponding one of the arithmetic units, the instruction included in the group determined by said group determining unit.

2. The processor according to claim 1,
wherein said group determining unit includes:
a resource decoding unit configured to specify, based on each of the instructions stored in said instruction buffer, (i) an information item on a resource to be defined or referred to and (ii) an information item on the arithmetic units executing the corresponding instructions; and
a dependency detecting unit configured to detect the first dependency and the second dependency based on the information items, on the resource and on the arithmetic units, specified by said resource decoding unit.

3. The processor according to claim 2,
wherein, when any given two of the instructions stored in said instruction buffer (i) define or refer to a common resource or (ii) are executed on a common arithmetic unit included in the arithmetic units, said dependency detecting unit is configured to determine that the first dependency is found between the any given two instructions.

4. The processor according to claim 2,
wherein said dependency detecting unit is configured to determine that the second dependency is found between each of the instructions stored in said instruction buffer and each of the dispatched instructions, when the instruction stored in said instruction buffer and the dispatched instruction (i) define or refer to a common resource or (ii) are executed by a common arithmetic unit.

5. The processor according to claim 4,
wherein said group determining unit further comprises:
a cycle decoding unit configured to extract, for each of the instructions stored in said instruction buffer, the number of cycles until the common arithmetic unit finishes executing the instruction; and
a non-ready detecting unit configured to (i) detect the resource for each of the instructions which require cycles as many as the predetermined number of the cycles or more until the instructions finish defining resources according to said cycle decoding unit and (ii) determine whether or not the resource is in a non-ready state in which the detected resource cannot be referred to in an next cycle, because a resource is not defined by an instruction which requires cycles as many as the predetermined number of the cycles to finish, and
when each of the instructions stored in said instruction buffer refers to a resource (i) to be defined by the dispatched instruction and (ii) determined to be in the non-ready state, said dependency detecting unit is configured to determine that the second dependency is found between the instruction and the dispatched instruction.

6. The processor according to claim 5,
wherein said group determining unit further includes a resource state storage table which stores whether or not each of the resources is in the non-ready state based on a result of the determination by said non-ready detecting unit, and
said dependency detecting unit is configured to determine whether or not the second dependency is found with reference to said resource state storage table.

7. The processor according to claim 6,
wherein said resource state storage table stores, for each of the resources, (i) a ready flag which indicates whether or not the resource is in a ready state that can be referred to at the next cycle and (ii) non-ready continuing cycles which indicates the number of cycles for which the non-ready state of the resource continues.

8. The processor according to claim 7,
wherein said resource state storage table subtracts a predetermined number of cycles from the non-ready continuing cycles stored in said resource state storage table for every dispatch of each of the instructions in the group to the arithmetic units by said dispatching unit.

9. The processor according to claim 7,
wherein, when the instructions stored in said instruction buffer define a common resource, said resource state storage table stores, based on the result of the extraction by said cycle decoding unit, a largest number of the cycles among the numbers of the cycles of the instructions as the non-ready continuing cycles.

10. The processor according to claim 8,
wherein, when one of the instructions stored in said instruction buffer defines a resource of which (i) ready flag stored in said resource state storage table has already indicated the non-ready state and (ii) number of the cycles has already been set as the non-ready continuing cycles, said resource state storage table overwrites, on the non-ready continuing cycles, the number of the cycles spent until one of the arithmetic units finishes executing the one instruction stored in said instruction buffer, only in the case where the number of the cycles until the corresponding arithmetic unit finishes executing the one instruction is larger than the non-ready continuing cycles.

11. The processor according to claim 7,
wherein said dependency detecting unit is configured to detect the second dependency with reference to the ready flag stored in said resource state storage table.

12. The processor according to claim 11,
wherein, when said dependency detecting unit detects one of the first dependency and the second dependency, said group determining unit is configured to determine, as the instruction group including the instructions to be dispatched to the corresponding arithmetic units at the next cycle, an instruction immediately before an instruction having the detected dependency in an executing order, both of the instructions being included in said instruction buffer.

13. The processor according to claim 12,
wherein, when determining another group based on the second dependency, said group determining unit is configured to (i) set, to a value indicating the ready state, the ready flag which has been referred to when obtaining the second dependency and (ii) set, to 0, the non-ready continuing cycles of an entry corresponding to the ready flag.

14. The processor according to claim 12,
wherein, once determining the instruction group, said group determining unit is configured to designate an instruction, immediately after the instruction group in an executing order of the instructions in the group, as an initial instruction of an instruction group to be dispatched at the next cycle.
